(19) United States
(12) Patent Application Publication
(10) Pub. No.: US 2011/0249557 A1
(43) Pub. Date: Oct. 13, 2011

(54) Centralized Wireless Manager (WiM) for Performance Management of IEEE 802.11 and a Method Thereof

(75) Inventors: Hedge Malati, Karnataka (IN); Kumar Pavan, Karnataka (IN); K.R. Vasudev, Karnataka (IN); S.V.R. Anand, Karnataka (IN); Kumar Anurag, Karnataka (IN); Kuri Joy, Karnataka (IN)

(73) Assignees: Indian Institute of Science, Karnataka (IN); Department of Information Technology, New Delphi (IN)

(21) Appl. No.: 13/139,979

(22) PCT Filed: Nov. 12, 2009
(86) PCT No.: PCT/IN2009/000637

§ 371 Date: Jun. 15, 2011

(30) Foreign Application Priority Data
Dec. 19, 2008 (IN) 2898/DEL/2008

(51) Int. Cl. H04W 24/02

(52) U.S. Cl. 370/235

(57) ABSTRACT

The present invention is an implementation of a network device called Wireless Manager (WiM) a centralized controller for QoS management of infrastructure WLANs based on the IEEE 802.11 DCF standards. The WiM queues and schedules packets from all the traffic flowing between the Access Points (APs) and the wireline LAN which requires no changes to the AP or the STAs, and can be viewed as implementing a Split-MAC architecture. The objectives of WiM are to manage various TCP performance related issues such as the throughput anomaly when STAs associate with an AP with mixed PHY rates, and upload download unfairness induced by finite AP buffers, and also to serve as the controller for VoIP admission control and handovers, and for other QoS management measures.

### FIELD OF INVENTION

The present invention is related to Wireless Communications and networks.

### BACKGROUND OF THE INVENTION

Some of the recent works that address the problem of wireless bandwidth management are [1], [2], [3], [4]. In [5] the authors discuss methods to overcome the performance anomaly seen in 802.11b WLAN [6].

Enterprise and home WLANs are based on the CSMA/CA based Distributed Coordination Function (DCF) MAC (medium access control) standardised in IEEE 802.11. It is well known that, due to the intrinsic properties of the DCF MAC protocol, there are several limitations to the QoS (quality of service) offered by WiFi WLANs. For example FIG. 1 shows that when out of 3, 6, 9, 12, etc., STAs if ⅓ of the Stations (STAs) are associated with an Access Point (AP) at the each of the rates 54 Mbps, 24 Mbps, and 6 Mbps, then the aggregate bulk download throughputs of the STAs associated at each rate is the same (just over 3 Mbps: bottom three curves in FIG. 1) and the total download throughput is about 9.5 Mbps (third curve from the top of FIG. 1), whereas when all the STAs are associated at 54 Mbps then the aggregate throughput is about 22.5 Mbps (the top curve); [6] also shows the same observation in a saturated node setting. In practical WLAN deployments, such mixed rate associations can be expected, thus leading to a reduction in the overall network throughput.

In [7] the authors analytically prove that the phenomenon can be cleanly resolved through configuring the initial contention window size inversely proportional to the bit-rate. This approach needs considerable amount of modifications to the AP to adapt the initial contention window dynamically.

Pilosof et al. [1] propose a solution that ensures that upstream and downstream throughputs are almost the same. The solution relies on manipulating the receiver TCP window in TCP ACK packets by software residing on the AP. This evidently requires modification to the AP firmware.

Detti et al. [2] suggest rate control techniques that essentially reserve half the available wireless bandwidth for downstream connections by placing a rate-limiter in the AP. Obviously, this also requires modifications of the AP software, which is difficult or impossible to do with commercial APs.

Malik et al. [3] also address the issue of unfairness between uplink and downlink TCP transfers in an 802.11 WLAN. They propose a scheme in which every STA opens a control TCP connection with the AP. For every control packet on this connection, a specific amount of data (called virtual maximum segment size) can be sent in the uplink direction; in addition, the AP exercises control by pacing ACKs. Again, it is evident that this proposed solution requires modifications to both the AP and the STAs, because the control TCP connection needs entities at both ends.

In [4] the authors propose a scheduling algorithm called Multirate Wireless Fair Scheduling (MWFS) to ensure packet-level QoS in terms of minimum throughput, fair channel share, and maximum packet delay. Instead of providing throughput-based fairness, MWFS improves fairness in terms of time share, which allows flows in good channel condition to receive more service proportional to their higher rates. The simulation results confirm the effectiveness of this scheduling algorithm in multi-rate wireless LANs.

The authors of [8] propose a mechanism called Weighted Fair-EDCA (WF-EDCA) to provide proportional fairness for 802.11 WLANs. With WF-EDCA, weighted fair service among different access categories (ACs) is provided, and strict priority service can also be implemented. This again requires changes to AP.

Some of the prominent vendors that manufacture WLAN controllers/switches for managing WLAN channel are Meru Networks, Extricom, Cisco/Airespace. The controllers seem to require proprietary APs. The QoS functionality provided by the access controllers could be as simple as mapping connections to the IEEE 802.11e access categories (ACs). Meru Networks and Extricom use a single channel across all the APs to provide QoS for voice over WLANs. The controllers of other vendors focus on RF management and/or security authentication. Thus, these approaches require either change to MAC parameters and/or modifications to the firmware running on the AP. On the other hand Wireless Manager (WiM) does not require any modification to the MAC parameters, and works with any existing IEEE 802.11 based infrastructure WLAN.

### OBJECTS OF THE INVENTION

One of the objects of the invention is to develop a centralized controller Wireless Manager (WiM) for management of IEEE 802.11 based Wireless Local Area Networks (WLAN).

Yet another object of the present invention is to develop a control method for QoS management of Wireless Local Area Network (WLAN).

### STATEMENT OF INVENTION

Accordingly, the present invention provides a centralized controller Wireless Manager (WiM) for management of IEEE 802.11 based infrastructure Wireless Local Area Networks (WLAN) comprising means for Quality of Service (QoS) management for bidirectional Transmission Control Protocol (TCP) transfers between remote servers and wireless clients; and means for Quality of Service (QoS) management for bidirectional Voice over Internet Protocol (VoIP) calls between remote servers and wireless clients; and the present invention also provides a control method for QoS management of Wireless Local Area Network (WLAN) comprises acts of implementing an hierarchical weighted fair queuing engine with an adaptive rate virtual server in Wireless Manager (WiM); and arriving at an optimal service rate to maximize the wireless channel utilization by measurement based online rate adaptation.

### BRIEF DESCRIPTION OF DRAWINGS

FIG. 1 shows showing TCP download throughputs for n STAs when all n STAs are associated at the PHY rates of 54 Mbps, or at 24 Mbps, or at 6 Mbps, and also when ⅓ of the STAs are at each of the three rates.

FIG. 2 (a) shows an enterprise network in which all traffic between the WLAN and the wireline network passes through one link.

FIG. 2 (b) shows wireline network with a Wireless Manager (WiM) device in place.

FIG. 3 shows Wireless Manager (WiM) High level software architecture.

FIG. 4 shows the core queuing and rate adaptation schematic of WiM.

FIG. 5 shows a hybrid test bed.

FIG. 6 shows aggregate throughput for bulk file downloads with WiM, for various number of STAs associated at 54, 24 and 6 Mbps plotted vs. the WiM service rate C.

FIG. 7 shows WiM service rate adaptation for various combinations of STAs associated at different PHY rates.

FIG. 8 shows Uplink and Downlink throughput vs. time 6 STAs associated 11, 5.5 and 2 Mbps PHY rates with and without WiM on a testbed shown in FIG. 6.

FIG. 9 shows throughputs of 10 STAs, 5 of which are performing uploads and 5 performing download. The STAs are associated at 11 Mbps with an AP. Results with and without WiM are shown for the hybrid testbed.

FIG. 10 shows upload throughputs obtained by 10 STAs associated at 11 Mbps with and without WiM on a hybrid testbed.

FIG. 11 shows upload and download throughputs for 2 STAs associated at 54 Mbps with and without WiM on a testbed with a Physical AP.

FIG. 12 shows upload throughputs for STAs associated at 54 Mbps with and without WiM on a testbed with a Physical AP.

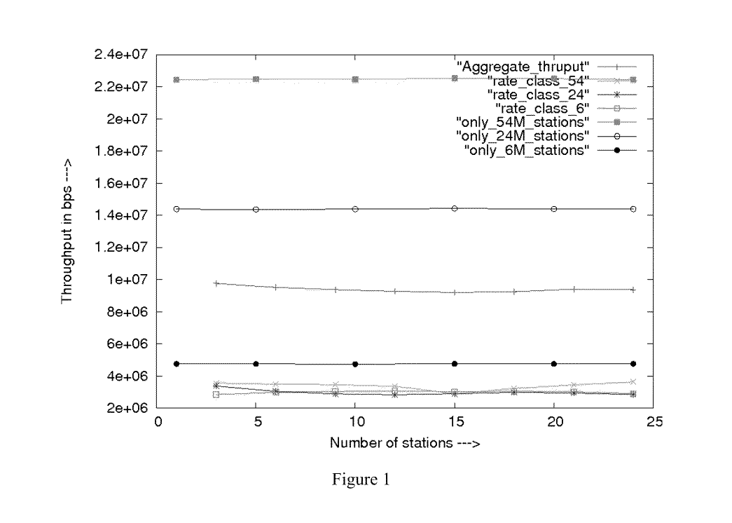

### DETAILED DESCRIPTION OF INVENTION

The primary embodiment of the present invention is a centralized controller Wireless Manager (WiM) for management of IEEE 802.11 based infrastructure Wireless Local Area Networks (WLAN) comprising means for Quality of Service (QoS) management for bidirectional Transmission Control Protocol (TCP) transfers between remote servers and wireless clients; and means for Quality of Service (QoS) management for bidirectional Voice over Internet Protocol (VoIP) calls between remote servers and wireless clients.

In yet another embodiment of the present invention the WiM provides preconfigured fairness policies for stations (STAs) by maximizing the wireless channel utilization compared to the networks without the WiM.

In still another embodiment of the present invention by managing TCP acknowledgements (ACK) for uplink TCP connections and TCP DATA for downlink TCP connections in separate queues in WiM the control mechanism removes TCP QoS related problems in a WLAN.

In still another embodiment of the present invention the packets from the queues are released using a Start Time Fair Queueing (STFQ) based packet scheduler.

In still another embodiment of the present invention the STFQ assigns appropriate virtual service times for the ACK and DATA packets to maximize the channel utilization compared to that without WiM.

In still another embodiment of the present invention the control mechanism eliminates unfairness among multiple uplink and downlink TCP connections for STAs associated with an AP.

In still another embodiment of the present invention the control mechanism eliminates unfairness among multiple uplink TCP connections from STAs to a remote server.

Another embodiment of the present invention is a control method for QoS management of Wireless Local Area Network (WLAN) comprises acts of implementing an hierarchical weighted fair queuing engine with an adaptive rate virtual server in Wireless Manager (WiM); and arriving at an optimal service rate to maximize the wireless channel utilization by measurement based online rate adaptation.

In yet another embodiment the WiM uses service differentiation between TCP and Voice provided by the IEEE 802.11e MAC layer protocol to provide predetermined TCP throughput.

In still another embodiment the WiM uses connection admission control (CAC) on the incoming VoIP calls.

In still another embodiment the WiM maximizes the wireless channel utilization by arriving at the optimal service rate in the presence of VoIP calls.

The present invention is a network device called Wireless Manager (WiM) a centralized controller for QoS management of infrastructure WLANs based on the IEEE 802.11 distributed coordination function (DCF) standards. The WiM queues and schedules packets from all the traffic flowing between the APs and the wireline LAN which requires no changes to the AP or the STAs, and can be viewed as implementing a Split-MAC architecture. The objectives of WiM were to manage various TCP performance related issues (such as the throughput anomaly when STAs associate with an AP with mixed PHY rates, and upload download unfairness induced by finite AP buffers), and also to serve as the controller for VoIP admission control and handovers, and for other QoS management measures.

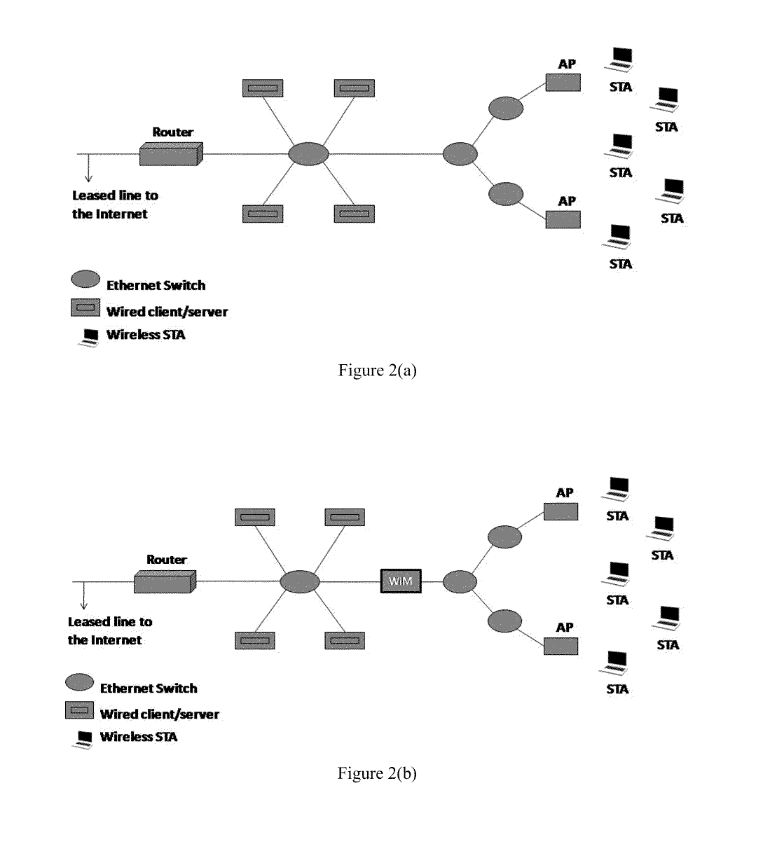

WiM is implemented on a device, where the device can be selected from a laptop or a PC and the operating system (OS) used is Linux or real time OS. The device is located (shown in FIG. 2) so that all packets that pass through the AP(s) also pass through the device. For TCP-controlled traffic, all packets (data or acknowledgments) going towards the WLAN are queued in a hierarchical WFQ queueing engine in WiM. These packets are then served by a virtual server that serves the queues using a fair queueing algorithm.

A key innovation here is that the rate of the virtual server is dynamically adjusted by a rate adaptation algorithm. The service rate is supposed to track an effective service rate on the wireless medium, which depends on the number of STAs connected at each PHY rate and on the fairness objective.

The basic idea of the WiM is:
(a) If packets are allowed to accumulate in the AP and the STAs, then the usual behavior of IEEE 802.11 DCF shows up. WiM aims to retain the AP queue within itself, and to manage the release of packets in such a way that the user configured throughput “fairness” objectives are met. Upload TCP connections are controlled by managing the downlink TCP ACKs in separate queues in WiM.
(b) WiM implements a hierarchical fair queuing engine with an adaptive rate virtual server. The choice of the virtual server's service rate is crucial to the proper working of WiM. If the service rate is too high, packet accumulation occurs in the AP and not in WiM, and thus WiM loses the ability to enforce a desired service ratio between the packets of the various connections. On the other hand if the WiM service rate is too low, then the WLAN “starves” and the system is inefficient. We have developed an on-line rate adaptation algorithm that dynamically adapts the service rate, even as the number of STAs associated at each rate varies.
(c) WiM schedules the packets such that there are no packet drops at the AP. Further, any desired throughput fairness (e.g., proportional fairness, or max-min fairness) between uplink and downlink data transfers can be achieved.
(d) WiM is able to handle connection admission control of CBR packet voice while providing the desired fairness among TCP connections. This is achieved by exploiting the service differentiation (between voice and TCP) provided by IEEE 802.11e, along with the adaptive rate virtual server described above.

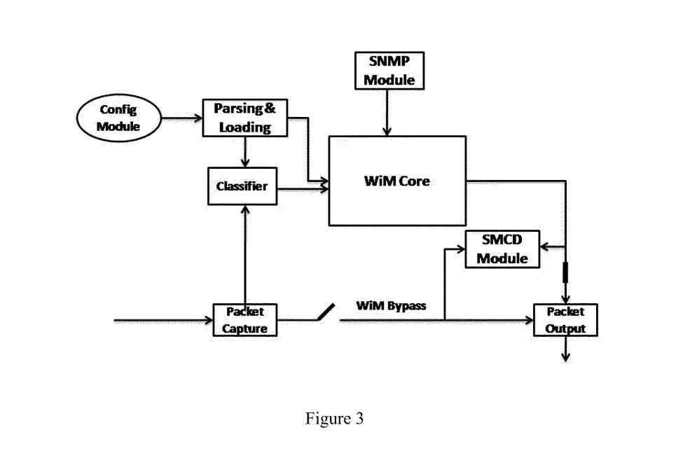

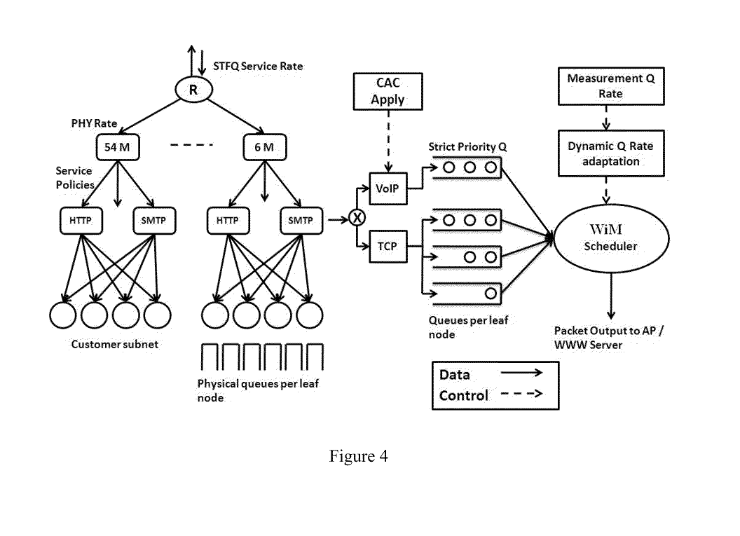

The packet capture module in FIG. 3 captures the incoming traffic from the wired link towards the AP. This is to buffer only the packets coming from the wired link, going towards the WLAN, in order to achieve the desired fairness in both directions. This is possible for TCP upload connections since the flow of ACKs in the downlink direction can be controlled, thereby controlling the TCP throughput. The packet classifier module places an arriving packet into one of the physical queues in a leaf node of the hierarchy shown in the left panel of FIG. 4. The hierarchy is created based on configurable policies that define the allocation of time on the wireless channel to various services such as http, ftp, and SMTP, to various users or to groups of users.

The information in the IP and TCP headers is used to form a 4-tuple i.e. source address, destination address, source port and destination port in identifying the direction and the leaf node in the hierarchy. The voice packets are given strict priority and appropriate DSCP marking is done in WiM before forwarding to the AP. These marked packets get mapped to the voice access category, AC3, within an 802.11e AP. WiM therefore takes advantage of the QoS offered by 802.11e. The SNMP module periodically polls the APs to obtain information on their associated STAs. For WiM to effectively handle the traffic from all the wireless STAs, it should have information about the APs, their connected STAs, and the rates at which the STAs are connected.

WiM uses SNMP probes to query the APs to obtain the number of connected STAs and their PHY rates. A database of all the APs and their associations is kept in WiM and is updated periodically. The WiM scheduler needs this information when adapting the virtual server's service rate. The SMCD (Statistics Module Capture Daemon) module captures and stores various statistics of the traffic passing through WiM. SMCD is a network traffic statistics monitoring module in WiM. It uses the policies configured into WiM and builds a statistics database of the WLAN traffic of all APs and STAs. This module can be run independently of WiM on a different machine and WLAN traffic can be monitored. It logs the on-line throughputs measurements for the policies defined in WiM such as individual STA and aggregate WLAN throughputs. The WiM Core is where all the QoS algorithms are implemented. Below the major building blocks of WiM Core are described. As shown in FIG. 4.

### Optimal Service Rate in WiM:

The methodology to achieve the desired throughput fairness requires the WiM scheduler to serve the packets at an optimal service rate. The optimal WiM service rate that permits the queueing to take place in WiM has to be obtained, so that it can control the throughput ratio, while keeping the WLAN maximally utilized.

As an example, if m STAs are associated with the AP, at the PHY rates rᵢ, 1≦i≦m. Each is carrying out a large file download from the server on the Ethernet LAN. Let us imagine m queues in WiM, one for each connection. The queues contain all the application level bits that need to be transmitted on the wireless medium for that connection. Thus, for each downlink data packet even its uplink TCP ACK is queued in WiM; and for each downlink ACK packet, the corresponding TCP data packets that will be generated are also queued in WiM.

In the example, ideal (bit level) fair queuing is used to serve these queues using the weights φᵢ=(φ₁, φ₂ . . . , φₘ), with Σⱼ₌₁^{m}φⱼ=1. Considering all the queues are backlogged. Then, out of b bits (where, b is a large number) sent by WiM, φᵢb bits belong to connection i. Let Cᵢ be the effective rate at which these bits are actually transmitted over the wireless medium, where we now account for the MAC and PHY overheads, and various interframe spaces. Then the time occupied on the medium by these bits from connection i is

$$\frac{{ϕ}_{i} b}{{C}_{i}} .$$

The total time taken to transmit all the b bits from the m connections is then given by

$${\sum }_{i = 1}^{m} \frac{{ϕ}_{i} b}{{C}_{i}} .$$

Dividing b by tins expression yields the effective rate at which the medium will carry bits above the MAC layer, i.e.

$${C}^{*} = \frac{1}{\frac{{ϕ}_{1}}{{C}_{1}} + \frac{{ϕ}_{2}}{{C}_{2}} + … + \frac{{ϕ}_{m}}{{C}_{m}}} \qquad ( 1 )$$

Thus, C* depends on the weights, φᵢ, 1≦i≦m, and the PHY rates at which the STAs are connected. For serving the queues of actual packets in WiM the following acts are used:
(a) Virtually replace each packet in the WiM queue by the number of higher layer bits (above MAC and PHY) that will need to be sent on the medium if the packet is released into the WLAN.
(b) Adapt the service rate of these queues (of virtual bits) so that the rate is a little less than C*. Adaptation of C* is needed since the population of active STAs, and the PHY rates at which they are associated will keep varying over time.

As an example, if mⱼ STAs are associated at rate rⱼ, 1≦j≦n, and n queues are present in WiM. Consider the following weights, for 1≦i≦n,

$${Φ}_{i} = \frac{{m}_{i} {C}_{i}}{{\sum }_{j = 1}^{n} {C}_{j}} \qquad ( 2 )$$

i.e., proportional fairness or time fairness (i.e., the target throughputs are proportional to the PHY rates of the connections), then

$${C}^{*} = \frac{{\sum }_{i = 1}^{n} {m}_{i} {C}_{i}}{{\sum }_{j = 1}^{n} {m}_{j}} \qquad ( 3 )$$

This arrives at the optimal service rate C* analytically for a set of weights φᵢ, 1≦i≦m. Typical WLAN scenarios include STAs connecting at different rates at random times of the day which necessitates adaptation of the WiM service rate as the number of STAs associated at each rate changes over time. There is another important reason why the WiM service rate needs to be adaptively learnt, and cannot simply be computed from Equation (1). Note that the rates C* may be achieved only if there are no wireless channel losses. When there are losses, due to the SINR for connection i not being the best possible for the PHY rate at which the STA is associated, then more packets will be sent on the medium than are accounted for by introducing virtual bits in the WiM queues. These losses will result in a smaller value of Cᵢ, which will show up if the WiM service rate is adapted based on on-line measurements. This algorithm requires information about the rates at which the STAs are associated with the AP, and this information is obtained by WiM via Simple Network Management Protocol (SNMP) polls to the AP.

### WiM Service Rate Adaptation:

It is arrived at the optimal service rate C* above analytically for a set of weights φᵢ, 1≦i≦m. The experimental result in FIG. 6 also illustrates the necessity of adapting the WiM service rate as the number of STAs associated at each rate changes over time. There is another important reason why the WiM service rate needs to be adaptively learnt, and cannot simply be computed from Equation (1). Note that the rates Cᵢ may be achieved only if there are no wireless channel losses. When there are losses, due to the SINR for connection i not being the best possible for the PHY rate at which the STA is associated, then more packets will be sent on the medium than are accounted for by introducing virtual bits in the WiM queues. These losses will result in a smaller value of Cᵢ, which will show up if the WiM service rate is adapted based on on-line measurements.

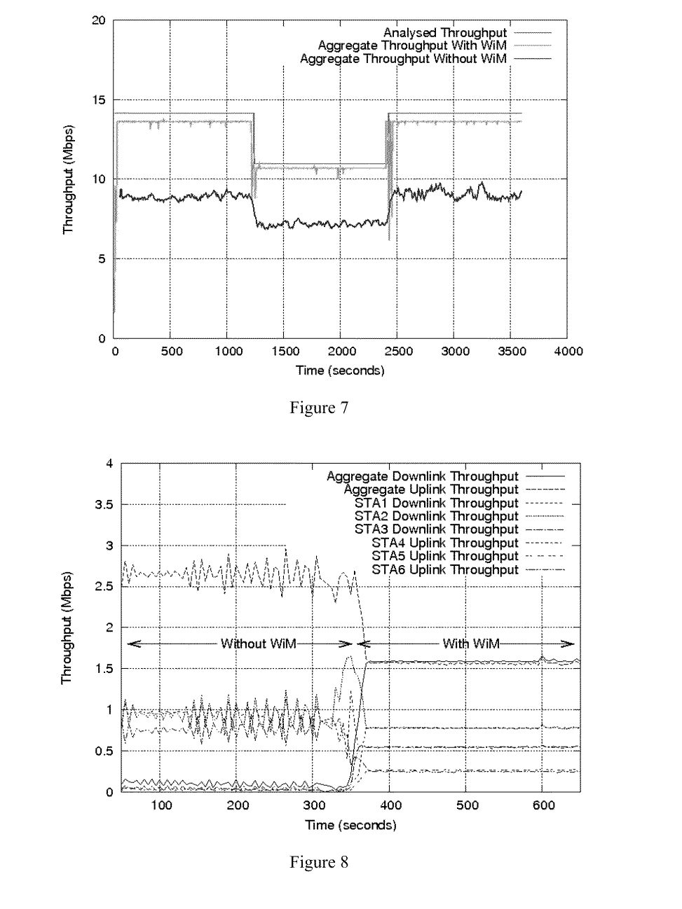

Based on the insights gained from FIG. 6 we have implemented a simple rate adaptation algorithm. This algorithm requires information about the rates at which the STAs are associated with the AP, and this information is obtained by WiM via SNMP polls to the AP. The performance of this approach is provided using the result from the hybrid testbed as shown in FIG. 7. The setup is the same as that for the “open-loop” experiment conducted for FIG. 6. The number of STAs in each rate class is changed at an interval of 20 minutes in the following order:
3 STAs in each rate class for first 20 minutes,
1, 2, and 3 STAs in 54 Mbps, 24 Mbps and 6 Mbps rate classes, respectively, for the next 20 minutes, and
4 STAs in each rate class for the last 20 minutes

FIG. 7 shows the values of C* for each interval, and the service rate (Ĉ*) to which WiM adapts. FIG. 7 also shows the aggregate throughput without WiM; this is the bottom plot in the figure. With WiM the aggregate throughput tracks (but falls a little short of) the computed value of C. When C changes, the adaptation takes 50 to 60 seconds.

### STFQ Based Packet Scheduler:

The WiM queues carry TCP DATA packets for download connections and TCP ACK packets for upload connections. Separate queues are maintained for TCP DATA and ACK packets. The WiM packet scheduler releases these packets into the WLAN. A TCP ACK packet transmitted by the AP results in a certain number of uplink DATA packets towards AP. When using an existing fair queueing scheduler, meant for a wired full-duplex link, is the half-duplex nature of the shared wireless link. The WiM packet scheduler therefore has to release DATA and ACK packets in such a way that it accounts for the time required on the medium for the packets that will be triggered by the reception of these packets by the STAs.

When an ACK packet corresponding to the uplink traffic is served, in the TCP steady state, this result in two uplink DATA packets at the STA because of TCP's delayed ACK mechanism. The scheduler replaces each packet queued in the WiM buffer with a number of “virtual bits” corresponding to the number of bits that will actually be carried by the WLAN MAC and PHY as a result of the packet being released into the WLAN. Thus, for each ACK, the scheduler assumes a number of virtual bits equal to an ACK and two DATA packets. For a DATA packet the scheduler assumes a number of virtual bits equal to a DATA packet and half an ACK (to roughly account for delayed ACKs).

Packet scheduling is performed using the Start Time Fair Queuing (STFQ) scheduling policy by suitably tagging start and finish numbers to each packet, and scheduling the packet transmissions appropriately. Let us consider an arrival of a packet, k+1, of virtual length lₖ₊₁^{(j)} (see above) into a queue j, at arrival instant αₖ₊₁^{(j)}. Let Fₖ^{(j)} denote the finish number of packet k in queue j.

V(t) denotes the (global) virtual time at time t. The start number Sₖ₊₁^{(j)} is computed as

Sₖ₊₁^{(j)}=max{Fₖ^{(j)},V(αₖ₊₁^{(j)})} (4)

### Then

$${F}_{k + 1}^{( j )} = {S}_{k + 1}^{( j )} + \frac{{l}_{k + 1}^{( j )}}{{φ}_{j}} \qquad ( 5 )$$

where F₀^{(j)}=0. In STFQ, instead of computing the virtual time from a simulation of the corresponding GPS system, the following approximations are made. The virtual time is initialised to 0, and increases in jumps as follows. When a packet arrives (say, at t), and if there is a packet in service, then STFQ approximates V(t) as the start time of the packet in service. If the packet arrives, at time t, to an idle system then the value of V(t) is taken to be the finish time of the last packet in the previous busy period.

Packets are released into the WLAN in the order of their start numbers. This is because the actual server is the wireless mediumod draft specm itself. After releasing a packet into the WLAN from queue i, the WiM scheduler allows time for the virtual bits corresponding to the packet to be served at the current WiM service rate Ĉ*.

Results from the Hybrid Testbed

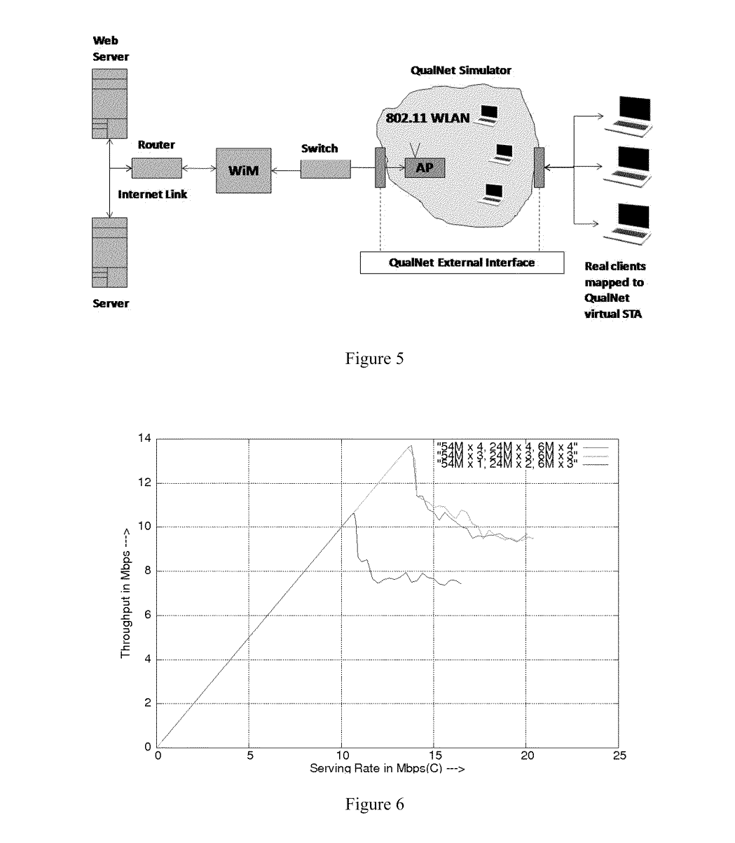

FIG. 5 showed a schematic of the hybrid testbed. The wireless PHY and MAC are simulated in Qualnet. The WAN between the web servers and the WiM is emulated by a computer with a propagation delay of 300 ms. The AP buffer is set to the default size of 100 packets. The wireless STAs and the web server run on the Linux OS. The default Linux kernel settings are used. Thus, TCP window scaling option is enabled, and delayed acknowledgment is on. Bulk file transfers (upload and downloads) are started between the STAs and the web server. WiM is configured to provide equal aggregate throughputs to uploads and downloads. In the experiments described below, initially WiM is bypassed (cases labeled “Without WiM”), and later WiM is introduced (cases labeled “With WiM”).

### STAs Associated at Multiple PHY Rates:

As an example consider 6 wireless STAs with half of them downloading files from the web server and the other half uploading files. The 6 wireless STAs are grouped into three sets of 2 STAs each associated at 11 Mbps, 5.5 Mbps and 2 Mbps, respectively. The plot in FIG. 8 shows the throughputs. During the initial 300 seconds WiM has been bypassed. The download transfers obtain very small throughputs (the cluster of 4 plots near the bottom, including the solid plot for aggregate throughput). The upload transfers obtain equal throughputs of 0.8-0.9 Mbps (the three jagged plots in the middle), with an aggregate throughput of about 2.6 Mbps (top-most plot). After WiM is introduced, the upload and download throughputs for each PHY rate become equal; the aggregate upload and download throughputs become about 1.578 Mbps each, totaling to 3.156 Mbps, which is just less than C*=3.26 Mbps obtained from the parameters of this experiment. Further, proportional service differentiation leads to the 11 Mbps, 5.5 Mbps, and 2 Mbps transfers obtaining aggregate throughputs of, respectively, 2×0.778 Mbps=1.556 Mbps, 2×0.545 Mbps=1.09 Mbps, and 2×0.255 Mbps=0.51 Mbps, which are roughly in the ratio of the C₁=4.89 Mbps, C₂=3.33 Mbps, and C₃=1.58, the ideal contention free TCP throughputs at 11, 5.5 and 2 Mbps. Thus, WiM provides a higher aggregate throughput for the network, while providing upload-download fairness, and proportional throughput differentiation across the rate classes.

### STAs Associated at a Single PHY Rate:

As shown in FIG. 5, as an example let 10 STAs are now associated with the AP at 11 Mbps PHY rate, keeping the rest of the setup the same. The following experiments are concerned with fairness between upload and download TCP transfers, and between just upload TCP transfers.

Uploads and Downloads: FIG. 9 shows plot of the throughputs of 10 TCP transfers one from each of 10 STAs, half of which perform uploads and the other half perform downloads, of large files to and from the web server. It is observed from the “Without WiM” segment that the download throughputs are very small; these are the plots near the bottom, before 300 sec. On the other hand the aggregate upload throughput is about 4.8 Mbps. WiM is introduced at 300 sec, and after a transient period, the aggregate upload and download throughputs become equal (about 2.4 Mbps each), and so do the individual throughputs of the 10 file transfers (about 0.48 Mbps each).

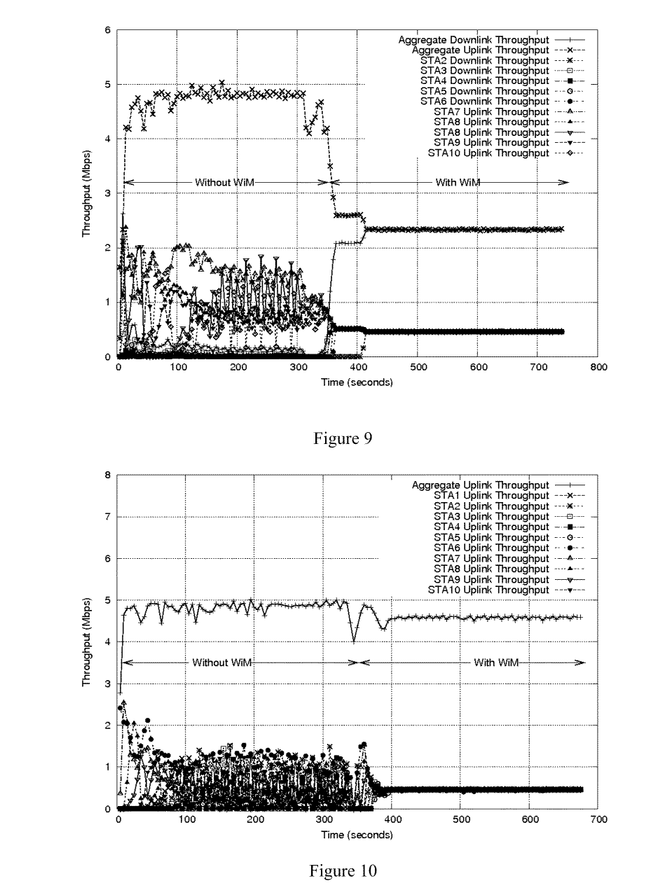

Uploads only: As an example let there be 10 upload file transfers from 10 STAs. FIG. 10 shows the results from the hybrid testbed. Before WiM is introduced there is considerable unfairness between the upload throughputs. On the other hand, with WiM the upload throughputs become exactly equal.

Results from a Testbed with a Physical AP

As another example, there is an IEEE 802.11g Cisco Aironet AP with which two Linux based laptops (STA1 and STA2) are associated at 54 Mbps. The remaining experimental testbed and parameters are the same as discussed earlier for the hybrid testbed. Delayed ACKs were enabled in the TCP receivers; RTS/CTS was used to send data packets, whereas Basic Access was used for TCP ACKs. With this the maximum possible throughput on the wireless medium (with 54 Mbps PHY rate) can be calculated to be 23.14 Mbps. The actual throughputs achieved will, of course, be less.

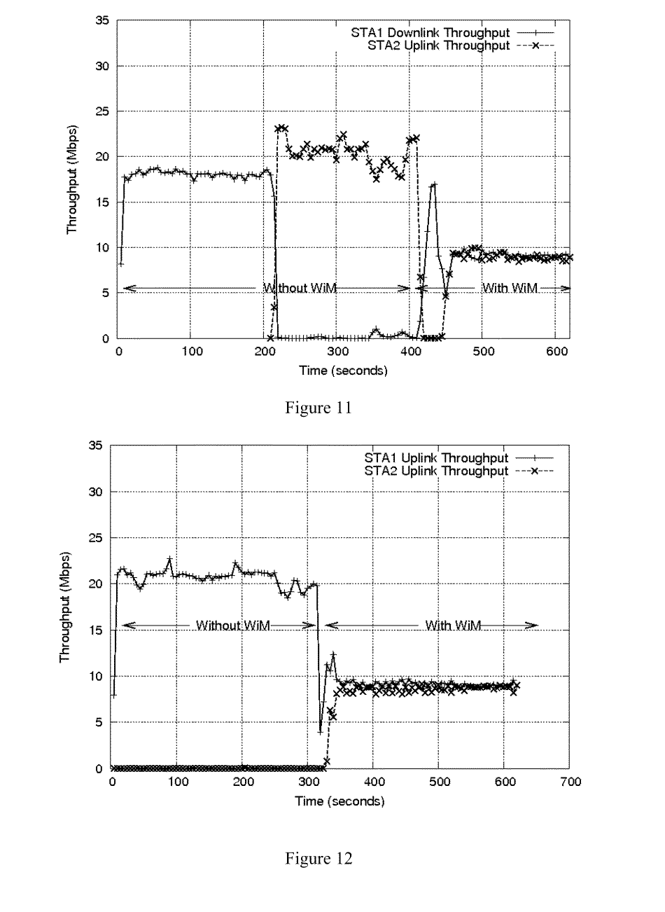

Upload and Download: As shown in FIG. 11 a large file download from the wireline web server was initiated from STA1, and was allowed to run for 200 seconds; and is observed a throughput of about 18.56 Mbps. Then an upload was started from STA2; the upload throughput was 21.2 Mbps, whereas the download throughput fell to 0.34 Mbps. The upload transfer obtains a slightly higher throughput than a download alone because some of the TCP ACKs are lost in the AP, and hence fewer bits are carried on the medium per data packet. Once WiM is turned on at 400 seconds, the throughputs equalise, giving a total throughput of about 19 Mbps.

Two Uploads: Another example shows unfairness among uploads, and WiM's ability to enforce fairness. FIG. 12 shows, in the “Without WiM” period only the upload from STA1 obtains throughput (about 21.5 Mbps), whereas the one from STA2 is starved completely. Once WiM is introduced, both the uploads obtain equal throughputs, with the aggregate being 19 Mbps.

### Policy Based Service Differentiation

As an example, consider two 11 Mbps stations, STA1 and STA2 each downloading a large file. STA1 is a privileged user and requires some guaranteed fraction of the total throughput. WiM provides for such configurable policies. Table I shows two cases. In the first row WiM is configured to give STA1 five times the throughput of STA2. In the second row STA1 gets nine times the throughput of STA2. In WiM a queue is created for each STA and appropriate weights are assigned. It is observed from Table I that WiM is able to provide the required service differentiation. The total throughput in each case is the same: 4.655 Mbps.

TABLE 1
Service differentiation using WiM.

| Configured | STA1 Thpt | STA2 Thpt | Total Thpt |
|---|---|---|---|
| Ratio | Mbps | Mbps | Mbps |
| 5:1 | 3.879 | 0.776 | 4.655 |
| 9:1 | 4.190 | 0.465 | 4.655 |

Finally, while the present invention has been described with reference to a few specific embodiments, the description is illustrative of the invention and is not to be construed as limiting the invention. Various modifications may occur to those skilled in the art without departing from the true spirit and scope of the invention as defined by the appended claims. The following are the references used.

### REFERENCES

[1] S. Pilosof, R. Ramjee, D. Raz, Y. Shavitt, and P. Sinha, “Understanding TCP fairness over wireless LANs,” INFOCOM 2003. Twenty-Second Annual Joint Conference of the IEEE Computer and Communications Societies. IEEE, vol. 2, pp. 863-872, March 2003.
[2] A. Detti, E. Graziosi, V. Minichiello, S. Salsano, and V. Sangregorio, “TCP fairness issues in IEEE 802.11 based access networks.”
[3] S. M. et al, “Bandwidth management for improving performance and fairness in IEEE 802.11 based wireless networks.” Submitted to IEEE Symposium on Computers and Communications, July 2004.
[4] Y. Yuan, D. Gu, W. Arbaugh, and J. Zhang, “Achieving packet level quality of service through scheduling in multi-rate wlans,” vol. 4, pp. 2730-2734, September 2004.
[5] S.-H. Yoo, J.-H. Choi, J.-H. Hwang, and C. Yoo, “Eliminating the performance anomaly of 802.11b,” Springer: Berlin, 2005.
[6] M. Heusse, F. Rousseau, G. Berger-Sabbatel, and A. Duda, “Performance anomaly in 802.11b,” April 2003.
[7] S. W. Kim, B.-S. Kim, and Y. Fang, “Downlink and uplink resource allocation in IEEE 802.11 wireless LANs,” IEEE Transactions on Vehicular Technology, vol. 54, pp. 320-327, January 2005.
[8] J. F. Lee, W. Liao, and M. C. Chen, “Proportional fairness for QoS enhancement in IEEE 802.11e WLANs,” pp. 503-504, November 2005.

We claim:

1. A centralized controller Wireless Manager (WiM) for management of IEEE 802.11 based infrastructure Wireless Local Area Networks (WLAN) comprising:
a. means for Quality of Service (QoS) management for bidirectional Transmission Control Protocol (TCP) transfers between remote servers and wireless clients; and
b. means for Quality of Service (QoS) management for bidirectional Voice over Internet Protocol (VoIP) calls between remote servers and wireless clients.

2. The controller as claimed in claim 1, wherein the WiM provides preconfigured fairness policies for stations (STAs) by maximizing wireless channel utilization compared to the networks without the WiM.

3. The controller as claimed in claim 1, wherein TCP acknowledgements (ACK) for uplink TCP connections and TCP DATA for downlink TCP connections are managed in separate queues of the WiM.

4. The controller as claimed in claim 3, wherein the packets from the queues are released using a Start Time Fair Queueing (STFQ) based packet scheduler.

5. The controller as claimed in claim 4, wherein STFQ assigns appropriate virtual service times for the ACK and DATA packets to maximize the channel utilization compared to the channels without WiM.

6. The controller as claimed in claim 4, wherein the control mechanism eliminates unfairness among multiple uplink and downlink TCP connections for STAs associated with an AP.

7. The controller as claimed in claim 4, wherein the control mechanism eliminates unfairness among multiple uplink TCP connections from STAs to a remote server.

8. A control method for QoS management of Wireless Local Area Network (WLAN) comprises acts of:
a. implementing an hierarchical weighted fair queuing engine with an adaptive rate virtual server in Wireless Manager (WiM); and
b. arriving at an optimal service rate to maximize the wireless channel utilization by measurement based online rate adaptation.

9. The method claimed in claim 8, wherein the WiM uses service differentiation between TCP and Voice provided by the IEEE 802.11e MAC layer protocol to provide predetermined TCP throughput.

10. The method claimed in claim 8, wherein the WiM uses connection admission control (CAC) on the incoming VoIP calls

11. The method as claimed in claim 8, wherein the WiM maximizes the wireless channel utilization by arriving at the optimal service rate in the presence of VoIP calls.
